(19) United States
(12) Patent Application Publication
(10) Pub. No.: US 2006/0026432 A1
(43) Pub. Date: Feb. 2, 2006

(54) Drive tracking system for removable media

(76) Inventors: Charles R. Weirauch, Loveland, CO (US); Jakob Gerrit Nijboer, Geldrop (NL); Christiaan Steenbergen, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/903,393

(22) Filed: Jul. 30, 2004

(51) Int. Cl. H04L 9/00

(52) U.S. Cl. 713/178

(57) ABSTRACT

A system, and associated methods, comprises a storage drive adapted to accommodate a removable storage medium and a central processing unit (“CPU”) configured to execute code. The code causes the storage drive to record audit information onto the storage medium. The audit information may comprise an identifying value identifying the storage drive and a time value indicative of when data was recorded to the storage medium.

### BACKGROUND

Some electronic systems include a storage drive that can store data on a removable storage medium. Because the storage medium is removable, the data on the storage medium can be stored by one or more storage drives. For various reasons, knowing which storage drive stored various data on the storage medium, and when during the drive's operational life, is desirable. For instance, a drive may begin experiencing faulty operation over time. Maintaining audit information pertaining to the drive may be useful to determine the nature of a drive's problems. In addition, audit information may facilitate forensic analysis in legal/criminal investigations.

### BRIEF SUMMARY

In accordance with at least some embodiments of the invention, a system and associated method comprise a storage drive adapted to accommodate a removable storage medium and a central processing unit (“CPU”) configured to execute code. The code causes the storage drive to record audit information onto the storage medium. The audit information may comprise an identifying value identifying the storage drive and a value indicative of when data was recorded to the storage medium.

### BRIEF DESCRIPTION OF THE DRAWINGS

For a detailed description of exemplary embodiments of the invention, reference will now be made to the accompanying drawings in which:

FIG. 1 shows a system in accordance with an exemplary embodiment of the invention;

FIG. 2 illustrates an embodiment in which a bitmap is used in conjunction with a datestamp and drive identifier (“ID”);

FIG. 3 shows a method embodiment according to the invention;

FIG. 4 shows an alternative embodiment in which a last cluster identifier value is used instead of a bitmap; and

FIG. 5 shows an alternative method embodiment according to the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The verb “record” means to store, write, or otherwise transfer data onto a storage medium.

### DETAILED DESCRIPTION

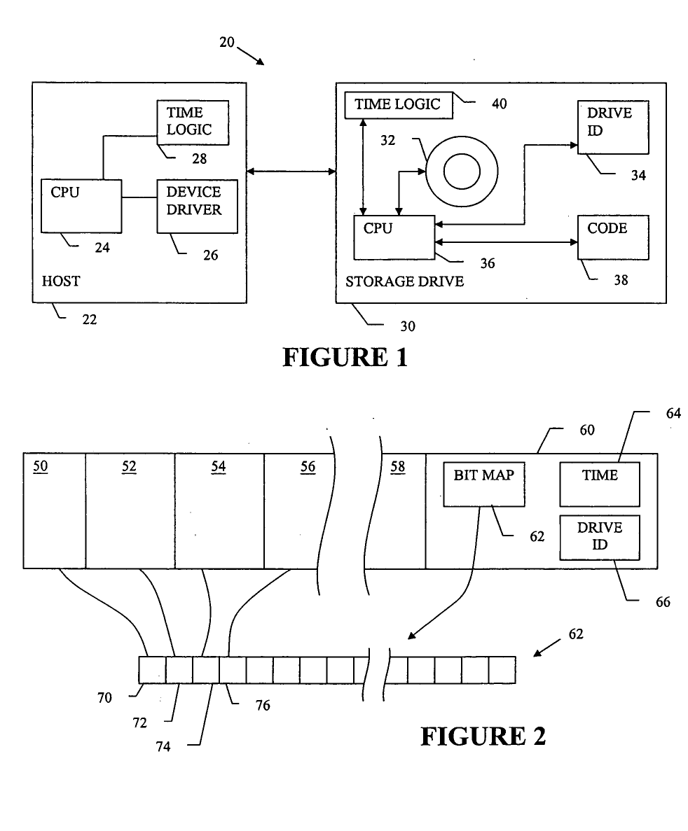

FIG. 1 illustrates a system 20 implemented in accordance with an exemplary embodiment of the invention. As shown, system 20 comprises a host 22 coupled to a storage drive 30. In general, the host 22 stores data on, and reads data from, the storage drive. As such, the host 22 represents a source of data for the storage drive and/or represents a consumer of data retrieved from the storage drive for use by the host 22 or other device. The host 22 may be implemented as a computer and the storage drive 30 may be external to the computer or may be located internal to the computer. The host 22 includes a central processing unit (“CPU”) 24 and a device driver 26. The device driver 26 comprises software that is executed by the CPU 24 and causes the CPU to perform one or more of the actions described herein. The host also includes time logic 28 that receives or keeps track of time. The time logic 28 may be implemented as a time of day circuit that can be programmed with the current time and can function to keep track of the progression of time. The CPU 24 interacts with the time logic 28 to obtain a value indicative of time. The value indicative of time may represent date, time of day, or both date and time of day. Alternatively, the value may comprise a sequence number that may be incremented in a suitable manner such as each time audit information is recorded to the storage drive 30. The term “time value” broadly comprises both approaches (time or date representation and sequence number). In the event a time value cannot be obtained, the time logic uses a predetermined value. The host 22 may also contain other components not specifically shown for sake of clarity.

The storage drive 30 is adapted to receive a removable storage medium 32. The storage medium 32 may comprise any suitable type of medium such as an optical disk, a magnetic disk, or solid state memory. Further, the storage medium may be implemented as a “write once” medium or a “re-writeable” storage medium. Data can be recorded onto a write once medium more than once, but once data is written to a write once medium (e.g., CD-R), such data cannot be overwritten or erased. Data on a re-writeable storage medium can be overwritten or erased.

The storage drive 30 may also include a CPU 36 and code 38 that can be executed by the CPU 36. One or more of the acts described herein may be performed by the storage drive's CPU 36 executing the code 38. The storage drive 30 may also include time logic 40 coupled to, or otherwise accessible to, the CPU 36. The time logic 40 can be programmed with the current time and then function to keep track of time going forward. For example, the host 22 may provide a value indicative of the current time from the host's time logic 28 to the storage drive's time logic 40 to permit the storage drive to track the progression of time.

The storage drive 30 also includes a drive identifier (“ID”) 34 that may uniquely identify the associated drive apart from all other drives. For example, the drive ID may comprise a serial number assigned by the drive manufacturer. In other embodiments, the drive ID 34 may be unique to at least some, but not all, other drives. It is generally sufficient for purposes of the subject matter disclosed herein that the drive ID 34 is such that there is a sufficiently low probability that the same storage medium 32 may be used in two or more drives having the same drive ID. The term “unique” (as in “unique” drive ID) is used in both contexts in this disclosure. The drive ID 34 may be stored in non-volatile memory in the storage drive 30 or may be hard-coded into the drive's circuitry (e.g., in unique patterns on traces formed on a printed circuit board contained in the drive). In some embodiments, the drive ID is permanent and thus not alterable. It is also suitable for the drive ID to be difficult to alter, if not permanent, without specialized equipment or processes. In other embodiments, the drive ID may comprise an identifier of the host 22 instead of, or in addition to, an identifier of the drive. Further still, the drive ID may comprise publicly available information pertaining to the system 10 or a user of system 10. The drive ID may additionally or alternatively contain private information that is lawfully retrievable pursuant to a valid legal process (e.g., a search warrant) to protect the privacy of a user of the system 10.

The drive ID 34 may comprise a value containing alphanumeric characters and/or other symbols. In at least one embodiment, the drive ID 34 comprises a 64-bit value comprising a manufacturer code (16 bits), a model code (16 bits) and a serial number (32 bits). Each different storage drive manufacturer may be assigned a unique manufacturer code and with 16 bits, there are more than 65,000 different manufacturer codes possible. Each different model, including revisions if desired, of a storage device may also be assigned a unique model code. With 16 bits used for the model code, there are more than 65,000 uniquely available model codes. The serial number generally is unique to each drive. As such, two drives of the same model and provided by the same manufacturer will still have different drive IDs because the serial number component of the drive IDs will differ. The three components of the drive ID (manufacturer code, model code, and serial number) may be concatenated together or otherwise combined or used together in any suitable manner.

In an alternative embodiment, every drive of a particular model may have the drive ID encoded in firmware running in the drives. In this embodiment, each drive of a particular model has the same 32-bit serial number. If the firmware is upgraded, the drive serial number is not changed and is still available. In accordance with another embodiment, the drive ID is generated by the host (e.g., by the CPU 24 in accordance with the device driver 26). When the drive is installed, the driver may prompt the operator for a number, which might, for example, be a human-readable serial number printed on the drive but not readable by the drive controller electronics. Alternatively, just the manufacturer number and model number could be manually entered and the device driver 26 could generate a random 32-bit serial number. Alternatively, the device driver could generate a serial number from a unique number associated with the host computer, such as a serial number of the firmware (e.g., BIOS) for the host. If the device driver provides the serial number, either the device driver should save the number in non-volatile memory, or the device driver should employ a deterministic algorithm to always recreate the same number every time the driver is loaded. If the device driver provides the serial number, the drive may obtain the drive identification from the device driver at initialization time.

In general, recorded data is formatted into addressable units that may be referred to in a variety of ways. Examples include sectors, blocks, clusters, tracks, or other unit terminology. In the following discussion, the term “addressable unit” is used to generically refer to any and all of the units of storage listed above or other known units. The recorded time value disclosed herein generally are used in conjunction with addressable units of storage on the storage medium. It should also be understood that a drive may read a portion of the storage medium, modify one sub-portion thereof, and rewrite the entire portion. In this read-modify-write scenario and in accordance with some embodiments, audit information for the sub-portion modified may be recorded and the time value may be used to determine which drive recorded the entire portion.

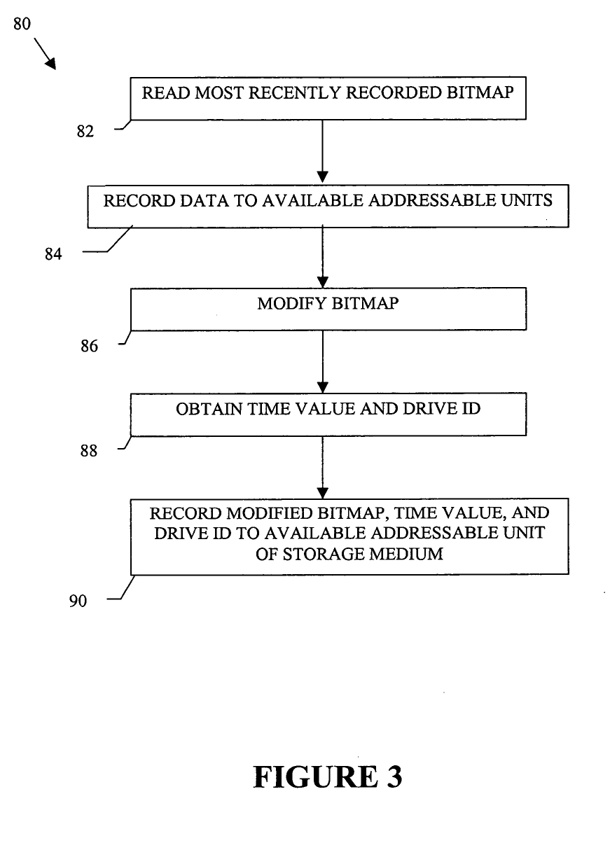

FIG. 2 conceptually illustrates the addressable units in which data can be recorded on a storage medium. The storage medium comprises a plurality of addressable units such as addressable units 50, 52, 54, 56, 58, and 60. One or more addressable units are adapted to store a bitmap 62, a time value 64, and a drive ID 66. The use of these values will be explained below in conjunction with FIG. 3. The bit map 62 is shown in an expanded form in FIG. 2 as containing a plurality of readable and writeable bits (such as bits 70, 72, 74, 76). In one embodiment, each bit in the bitmap 62 corresponds to an addressable unit on the storage medium. For example, bit 70 corresponds to addressable unit 50, bit 72 corresponds to addressable unit 52, bit 74 corresponds to addressable unit 54, and bit 76 corresponds to addressable unit 56. Alternatively, each bit may correspond to a fixed number of addressable units. Each bit in the bitmap may be written as a logic “0” or a logic “1” to signify whether or not the corresponding addressable unit has been recorded with data by the host 22. Accordingly, a bit value of 0 may indicate that the corresponding addressable unit has not been recorded with data while a bit value of 1 may indicate that the corresponding addressable unit has indeed been recorded with data. In an alternative embodiment, a bit value of 0 may indicate that the corresponding addressable unit has been recorded with data while a bit value of 1 may indicate that the corresponding addressable unit has not been recorded with data. By examining the state of each bit in the bitmap 62, a determination can be made as to which addressable units have been recorded with data and which addressable units have not been recorded with data. For write once storage media, the bitmap 62 may be used to determine in which addressable units to record new data. The bitmap 62 may be used for an additional purpose as will now be explained.

In accordance with various embodiments of the invention, one or more bitmaps 62 may be recorded onto the storage medium 32 dependent, for example, on the number of times the host records data to the storage medium. The bitmaps 62 may be created and modified by the storage device's CPU 36 executing code 38, by the host's CPU 24 executing the device driver 26, or by a combination of both CPUs executing their respective code/driver. In at least some embodiments, a new bitmap is created, or modified from a previously recorded bitmap, and recorded onto an available, non-user data area of the storage medium when new data is recorded onto one or more addressable units of the storage medium 32. The process of creating the new bitmap may occur concurrent with the recording of new data or at any one or more subsequent points in time, for example, just prior to ejecting the storage medium from the storage drive 30, powering down the storage drive 30 or host 22, after an elapsed period of time since data was recorded, or when a pre-determined amount of data is recorded to the storage medium 32. Each newly created or modified bitmap may identify the addressable units that have data previously recorded or recorded concurrently with the creation of the new bitmap. Recorded with each bitmap is a time value 64 that is provided by the host's time logic 28. The time value 64 corresponding to a bitmap is indicative of the time at which the bitmap was created and recorded onto the storage medium. The time value 64 thus functions as a date or time stamp for the bitmap and may alternatively comprise a sequence number as explained previously. A drive ID 66 is also recorded with each corresponding bitmap and time value and identifies the particular storage drive 30 that was used to record the bitmap 62 and time value 64 onto the removable storage medium 32. As such, a series of bitmaps 62/time values 64/drive IDs 66 may be created and recorded onto the storage medium to form an “audit trail.”

Referring to FIG. 3, an exemplary process 80 is shown comprising acts 82, 84, 86, 87, 88, and 90. The process 80 of FIG. 3 may be used in an embodiment in which data can be recorded onto the addressable units of the storage medium in a non-contiguous (e.g., random) order. At block 82, the host 22 reads the most recently stored bitmap 62 (identified as being the most recently stored by virtue of the time values 64). Of course, the first time the storage medium is accessed, there will not already be a bitmap 62 stored thereon, in which case, a bitmap is created rather than read from the storage medium. The most recently recorded bitmap 62 can be examined to determine which addressable units, if any, are still available for recording new data. To the extent any addressable units are available, the host 22 records data to one or more of the available addressable units of the storage medium (block 84). At block 86, the host 22 modifies the bitmap to identify the newly recorded addressable units. The newly modified bitmap identifies the recorded addressable units identified in the previous bitmap as well as the additional sectors recorded in block 84. At block 88, the host obtains a time value and drive ID. The time value generally corresponds to a time (e.g., date, time of day, and sequence number) at which the new bitmap is created. In the case of the use of sequence numbers, the new time value is generated by incrementing the previous sequence number during the previous time that process 80 was performed. A high degree of accuracy of the time value relative to the instant in time at which the new bitmap was created generally is not needed, although any degree of precision is acceptable. Generally, the accuracy and resolution of the time value is in accordance with whatever the system architect desires for a given application. In some embodiments, for example, recording the date on which new data is recorded onto the storage medium is sufficient. In other embodiments, time value may reflect the date and hour at which the storage medium was created with new data. In still other embodiments, the time value may reflect the date and time of day to a resolution of an hour, minute, second, or other interval of time. At 90, the host records the newly created bitmap along with the time value and drive ID to an available addressable unit of the storage medium 32. The drive ID obtained by the host 22 in block 88 comprises the drive ID 34 associated with the storage drive 30 being used to record the new data. In at least some embodiments, blocks 86, 88 and 90 may be performed at about the time that block 84 is performed or during the process of ejecting the storage medium 32 from the storage drive, or at an alternative instant such as during the process of shutting down the system 20. The order of the acts depicted in FIG. 3 can be varied as is appropriate. For instance, block 88 can be performed at other times such as before block 84.

The acts depicted in FIG. 3 are generally performed by the coordinated action of the host 22 and storage drive 30. In some embodiments, one or more of the acts shown in FIG. 3 may be performed exclusively by the host computer. In other embodiments, one or more of the acts shown in FIG. 3 may be performed exclusively by the storage drive 30. In yet other embodiments, some acts of FIG. 3 may be performed by the host 22 while other acts are performed by the storage drive. For example, the storage drive 30 may modify the bitmap (block 86), while at block 88 the host 22 may obtain the time value. Alternatively, the host 22 may program the time logic 40 in the storage drive 30, thereby permitting the storage drive to keep track of time. In this embodiment, the storage drive 30 may accordingly obtain a time value in block 88.

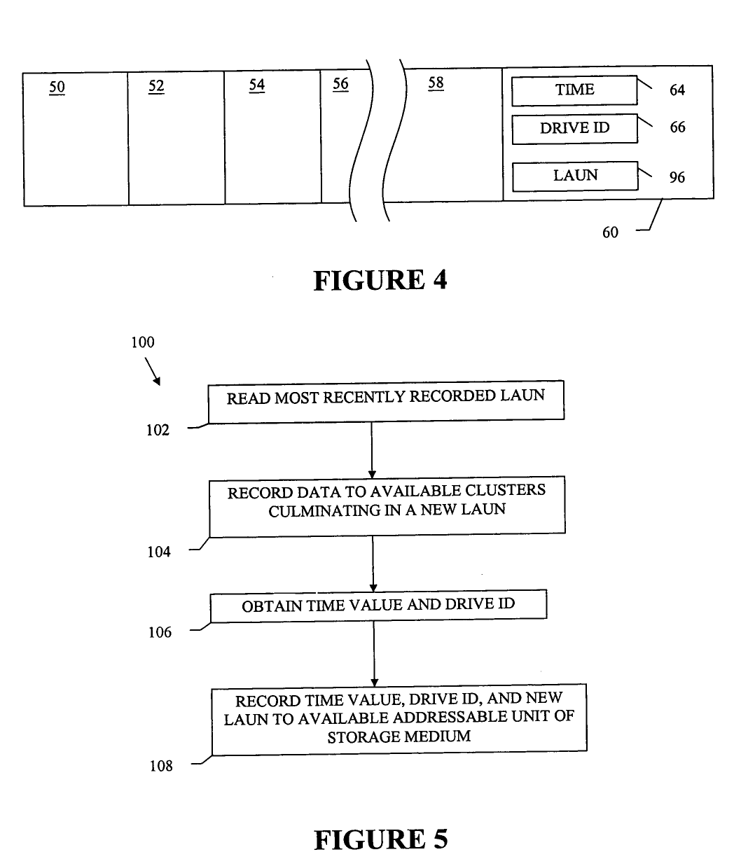

In an alternative embodiment to that described above in which sectors are recorded in a non-contiguous order, the host 22 records data to the storage medium 32 in a particular order. For example, each addressable unit is numbered in consecutive order beginning with addressable unit number 0 and including addressable unit numbers 1, 2, 3, and so on. FIG. 4 illustrates an alternative embodiment of the invention in which the host 22 records data onto the storage medium 32 in consecutive addressable unit order. Rather than using a bitmap 62, the host 22 stores a last addressable unit number (“LAUN”) 96 onto the storage medium 32 along with a time value 64 and drive ID 66. The LAUN 96 corresponds to the highest numbered addressable unit previously recorded by the host 22. For example, if the host 22 previously wrote to addressable unit numbers 0 through 9, the LAUN 96 would contain the number 9 (or a suitable representation of the number 9 such as the binary equivalent for 9). In this embodiment, the previously recorded addressable units (and thus unavailable addressable units for purposes of writing new data in a write once storage medium), are determined on the basis of the LAUN. All sectors with numbers less than or equal to the LAUN have recorded data contained therein. All addressable units with numbers greater than, or equal to or greater than, the LAUN are available for recording new data. In at least some embodiments, a plurality (e.g., a pair) of LAUNs can be used to define a range of addressable units that contain recorded data. As with the bitmaps described above, a series of LAUNs 96/time values 66/drive IDs 64 can be recorded onto the storage medium 32 to provide an audit trail.

FIG. 5 illustrates an exemplary process 100 usable in conjunction with the embodiment of FIG. 4. At 102, the host 22 reads the most recently stored last addressable unit number from the storage medium. The most recently stored LAUN can be used to determine the addressable units that already have recorded data and the addressable units that are still available for recording new data. The most recently stored LAUN is determined by examining the time values 64 associated with each such LAUN 96 on the storage medium. At 104, the host records new data onto one or more available addressable units thereby culminating in a new LAUN. At 106, the host (or storage drive) obtains a new time value and drive ID as described previously. At 108, the host (or storage drive) records the newly obtained time value and drive ID along with the newly determined LAUN to an available addressable unit on the storage medium. As explained above, one or more of the acts depicted in FIG. 5 may be performed exclusively by the host 22 or exclusively by the storage drive 30. Alternatively, some acts may be performed by the host, while other acts may be performed by the storage drive. The acts can be performed in an order other than that shown as explained above with regard to FIG. 3 and some acts may be omitted.

The various embodiments described above result in an audit trail containing time or sequence information being stored on the storage medium. In general, each time the host 22 records data onto the storage medium, audit trail information is also included to identify the storage drive or system that was used to record the data, as well as time or sequence information associated with the recording and an indication of the addressable units that were recorded by the corresponding storage drive. This information can be used in a variety of ways. For example, forensic analysis can be performed to discern information about a particular storage drive or model of storage drive that experiences errors. If a particular model of storage drive is determined to experience errors, an assessment can be as to when during the drives' life cycle the errors typically occur. Further still, such audit trail information can be useful in a criminal or other type of legal investigation. The use of the aforementioned audit trail information is not limited by the preceding examples.

Numerous variations and modifications will become apparent to those skilled in the art once the above disclosure is fully appreciated. For example, the teachings provided herein are applicable to computer systems as well as stand-alone storage devices such as optical disc video recorders.

What is claimed is:

1. A system, comprising:
a storage drive adapted to accommodate a removable storage medium; and
a central processing unit (“CPU”) configured to execute code to cause the storage drive to record audit information onto the storage medium, the audit information comprising an identifying value identifying the storage drive and a time value indicative of when data was recorded to the storage medium.

2. The system of claim 1 wherein the audit information also comprises data storage information indicative of addressable units of the storage medium that contain recorded data.

3. The system of claim 2 wherein the data storage information comprises a bitmap that includes a plurality of bits, each bit corresponding to at least one different addressable unit, and each bit indicates whether the corresponding at least one different addressable unit contains recorded data.

4. The system of claim 2 wherein the data storage information comprises an addressable unit number indicative of a particular addressable unit, said addressable unit number usable to determine the addressable units that have recorded data and the addressable units that do not have recorded data.

5. The system of claim 2 wherein the data storage information comprises a pair of addressable unit numbers that define a range of addressable units that contain recorded data.

6. The system of claim 1 wherein the at least one time value comprises a value selected from a group consisting of date, time of day, and sequence number.

7. The system of claim 1 wherein the audit information comprises at least one value, each value representing an event associated with recording new data onto the storage medium.

8. The system of claim 7 wherein the event comprises an event selected from the group consisting of length of time, amount of data recorded, ejection of the storage medium form the storage drive, and powering down the storage drive.

9. The system of claim 1 further comprising a host coupled to the storage drive, the host is adapted to record data onto the storage medium.

10. A system, comprising:
time logic adapted to track time; and
a central processing unit (“CPU”) adapted to execute code that causes the CPU to obtain a time value from the time logic and record the time value on a removable storage medium, the time value being indicative of the time at which data is recorded onto the removable storage medium.

11. The system of claim 10 wherein the system further comprises a storage drive that is adapted to receive the removable storage medium, and the code also causes the CPU to record a storage drive identifier value onto the removable storage medium, the identifier value uniquely identifies the storage drive.

12. The system of claim 11 wherein the code further causes the CPU to generate a bitmap indicative of portions of the removable storage medium that contain recorded data, to obtain the time value, and to record the bitmap, time value and the storage drive or system identifier onto the storage medium.

13. The system of claim 11, wherein the code further causes the CPU to record an addressable unit number, the time value and the storage drive identifier onto the removable storage medium, wherein the addressable unit number is usable to determine storage medium addressable units that have recorded data.

14. A method, comprising:
reading a most recently recorded data location identifier, said data location identifier indicative of at least one location on a removable storage medium in which data is recorded;
recording data to the removable storage medium;
creating a new data location identifier; and
recording the new data location identifier and a time value onto the removable storage medium.

15. The method of claim 14 further comprising obtaining a drive identifier indicative of a storage drive usable to record data onto the removable storage medium and recording the drive identifier onto the removable storage medium with the new data location identifier and the time value.

16. The method of claim 14 wherein recording the time stamp comprises recording a value selected from the group consisting of date, time of day, and sequence number.

17. A method, comprising:
retrieving an audit trail from a storage medium; and
based on the audit trail, determining when data was stored on the storage medium and which of a plurality of storage drives were used to store said data on the storage medium.

18. The method of claim 17 wherein retrieving the audit trail comprises retrieving at least one time value stored on the storage medium and a storage drive identifier associated with each time value.

19. A system, comprising:
means for recording data onto a removable storage medium; and
means for generating an audit trail containing information indicative of when data was recorded onto the removable storage medium.

20. The system of claim 19 further comprising means for recording the audit trail onto the removable storage medium.

21. The system of claim 19 further comprising means for generating a time value to be included in the audit trail.

22. A storage drive adapted to receive a removable storage medium, comprising:
logic adapted to receive or track time; and
a central processing unit (“CPU”) adapted to execute code that causes the CPU to obtain a time value and record the time value on the removable storage medium, the time value being indicative of the time at which data is recorded onto the removable storage medium.

23. The storage drive of claim 22 wherein the code also causes the CPU to record a storage drive identifier value onto the removable storage medium, the identifier value uniquely identifies the storage drive.

24. The storage drive of claim 23 wherein the code further causes the CPU to generate a bitmap indicative of portions of the removable storage medium that contain recorded data, to obtain the time value, and to record the bitmap, time value and the storage drive identifier onto the storage medium.

25. The storage drive of claim 23, wherein the code further causes the CPU to record an addressable unit number, the time value and the storage drive identifier onto the removable storage medium, wherein the addressable unit number is usable to determine storage medium addressable units that have recorded data.

26. The storage drive of claim 23 wherein the time stamp comprises a value selected from the group consisting of date, time of day, and sequence number.

27. The storage drive of claim 23 wherein the time stamp comprises a predetermined value if the drive cannot obtain the time stamp information.
